(19) United States
(12) Patent Application Publication
(10) Pub. No.: US 2024/0245943 A1
(43) Pub. Date: Jul. 25, 2024

(54) FIRE EXTINGUISHING SYSTEM

(71) Applicant: SENJU SPRINKLER CO., LTD., Tokyo (JP)

(72) Inventors: Ryoichi SUZUKI, Tokyo (JP); Kazushi TAKAHASHI, Tokyo (JP); Koki SATO, Tokyo (JP); Takao HATAKEYAMA, Tokyo (JP)

(73) Assignee: SENJU SPRINKLER CO., LTD., Tokyo (JP)

(21) Appl. No.: 18/417,780

(22) Filed: Jan. 19, 2024

(30) Foreign Application Priority Data
Jan. 23, 2023 (JP) 2023-008203

(51) Int. Cl. A62C 35/60; A62C 35/62

(52) U.S. Cl. CPC A62C 35/60; A62C 35/62

(57) ABSTRACT

A fire extinguishing system comprises a first fire extinguishing part 10 that supplies a fire extinguishing agent to a protection target 90; and a second fire extinguishing part 20 that sprays water to an evacuation route 110. An activation temperature of the second fire extinguishing part 20 may be lower than an activation temperature of the first fire extinguishing part 10. The fire extinguishing system may further comprise a third fire extinguishing part 30 that sprays water to the protection target 90, wherein the third fire extinguishing part 30 may spray water after starting supply of the fire extinguishing agent by the first fire extinguishing part 10, and wherein the third fire extinguishing part 30 may be activated when the first fire extinguishing part 10 cannot extinguish a fire.

### TECHNICAL FIELD

The present invention relates to a fire extinguishing system using a fire extinguishing agent or water.

### CROSS-REFERENCE TO RELATED APPLICATION

The present application claims the priority of Japanese Patent Application No. 2023-008203 filed on Jan. 23, 2023, the contents of which are entirely incorporated by reference.

### BACKGROUND ART

Conventionally, there has been provided a fire extinguishing system that automatically extinguishes a fire when a fire occurs. For example, JP 2002-35153 A provides a fire extinguishing facility in a coating booth in which a target to be coated such as an automobile is coated by a robot. An aspect is disclosed in which, in the fire extinguishing facility, a first fire sensor that senses a small fire immediately after ignition in the event of a fire, a water mist spray head that injects a water mist composed of fine water particles in conjunction with an activation of the first fire sensor, a second fire sensor that senses an expanded fire when the fire is further expanded without being extinguished, and a gas spray head that injects an inert gas in conjunction with an activation of the second fire sensor are disposed in the coating booth.

JP H8-332244 A discloses an aspect in which an inert gas is injected and sealed in a sealed compartment within a predetermined time to reduce an oxygen concentration in the compartment to 16% to 18%, and then fine water spray having a particle size of 10 to 200 μm is injected into the compartment to extinguish a fire.

### SUMMARY OF INVENTION

### Problem to be Solved by Invention

Unlike the conventional aspect, the present invention provides a fire extinguishing system that realizes effective fire extinguishment while giving priority to life saving by changing fire extinguishing means between a protection target and an evacuation route.

### Means for Solving Problem

### [Concept 1]

A fire extinguishing system may comprise:
a first fire extinguishing part that supplies a fire extinguishing agent to a protection target; and
a second fire extinguishing part that sprays water to an evacuation route.

### [Concept 2]

A fire extinguishing system may further comprise:
a first fire extinguishing part that supplies a fire extinguishing agent to a protection target; and
a second fire extinguishing part that sprays water to an evacuation route,
wherein an activation temperature of the second fire extinguishing part may be lower than an activation temperature of the first fire extinguishing part.

### [Concept 3]

A fire extinguishing system may comprise:
a first fire extinguishing part that supplies a fire extinguishing agent to a protection target;
a second fire extinguishing part that sprays water to an evacuation route; and
a third fire extinguishing part that sprays water to the protection target,
wherein the third fire extinguishing part may spray water after starting supply of the fire extinguishing agent by the first fire extinguishing part, and
wherein the third fire extinguishing part may be activated when the first fire extinguishing part cannot extinguish a fire.

### [Concept 4]

In the fire extinguishing system according to any one of concepts 1 to 3,
the fire extinguishing agent may include a gas, powders, or a foam fire extinguishing chemical.

### [Concept 5]

In the fire extinguishing system according to any one of concepts 1 to 4,
the first fire extinguishing part may have a plurality of first fire extinguishing units,
there may be a plurality of protection targets, and
at least one first fire extinguishing unit may be provided corresponding to each of the protection targets.

### [Concept 6]

In the fire extinguishing system according to any one of concepts 1 to 5,
the second fire extinguishing part may include a plurality of second fire extinguishing units disposed along the evacuation route, and
the fire extinguishing agent may be not supplied to the evacuation route.

### [Concept 7]

The fire extinguishing system according to concept 1 or 2, or any one of concepts 4 to 6 having the feature of concept 1 or 2 may further comprise a third fire extinguishing part that sprays water to the protection target, and
wherein the third fire extinguishing part may spray water after starting supply of the fire extinguishing agent by the first fire extinguishing part.

### [Concept 8]

In the fire extinguishing system according to concept 7,
an activation temperature of the third fire extinguishing part may be higher than an activation temperature of the first fire extinguishing part.

### [Concept 9]

In the fire extinguishing system according to concept 7 or 8,
a distance from the protection target to a first detection unit for activating the first fire extinguishing part may be shorter than a distance from the protection target to a third detection unit for activating the third fire extinguishing part.

### [Concept 10]

In the fire extinguishing system according to any one of concepts 1 to 9,
a shielding member may be provided above a first detection unit for activating the first fire extinguishing part.

### [Concept 11]

In the fire extinguishing system according to any one of concepts 1 to 10,
the second fire extinguishing part may be manually activated.

### [Concept 12]

In the fire extinguishing system according to any one of concepts 1 to 11,
the second fire extinguishing part may be activated by an activation signal of the first fire extinguishing part and an activation signal of a second detection unit provided at an upper region of the first fire extinguishing part.

### Effect of Invention

As an aspect of the present invention, when the fire extinguishing system having a first fire extinguishing part that supplies a fire extinguishing agent to a protection target; and a second fire extinguishing part that sprays water to an evacuation route is adopted, it is possible to provide a fire extinguishing system that realizes effective fire extinguishment while giving priority to life saving by using different fire extinguishing means between a protection target and an evacuation route.

### BRIEF DESCRIPTION OF FIGURES

FIG. 1 is a diagram showing one aspect of a first fire extinguishing part according to an embodiment of the present invention;

FIG. 2 is a diagram showing one aspect of a second fire extinguishing part according to the embodiment of the present invention;

FIG. 3 is a diagram showing one aspect of a plurality of first fire extinguishing units and a plurality of third fire extinguishing units provided for different protection targets;

FIG. 4 is a diagram showing another aspect of the second fire extinguishing part according to the embodiment of the present invention; and

FIG. 5 is a diagram showing an aspect in which a second detection unit is provided at a position above the first fire extinguishing part in the embodiment of the present invention.

### DETAILED DESCRIPTION

### Embodiment

### «Configuration»

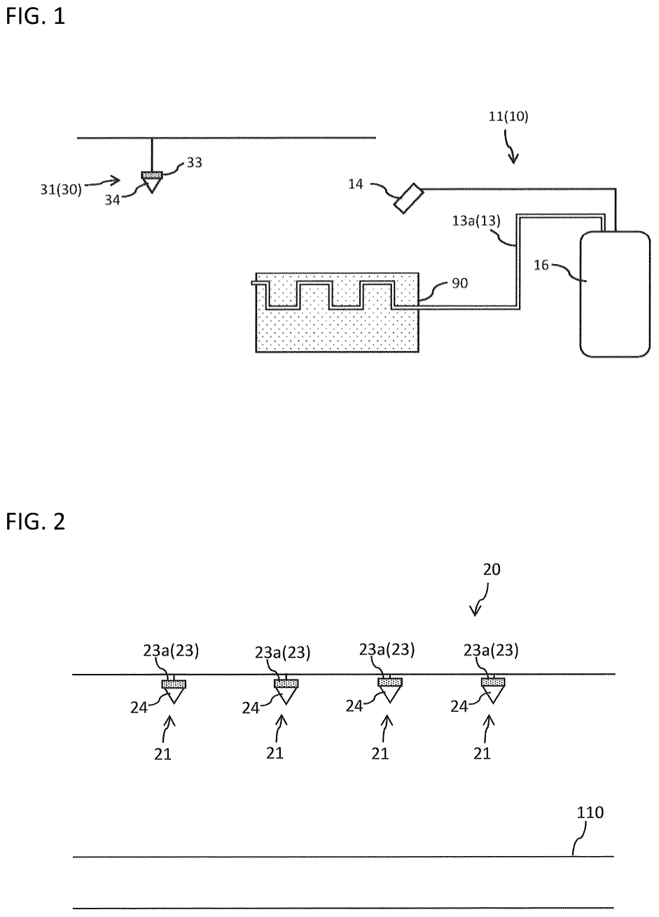

As shown in FIGS. 1 and 2, the fire extinguishing system has a first fire extinguishing part 10 that supplies a fire extinguishing agent to a protection target 90, and a second fire extinguishing part 20 that sprays water to an evacuation route 110. Here, only the water supplied from the second fire extinguishing part 20 may be supplied to the evacuation route 110, and the fire extinguishing agent may not be supplied. By adopting such an aspect, only water is supplied to a route through which a person escapes. The fire extinguishing agent of the present embodiment is a concept that does not include water.

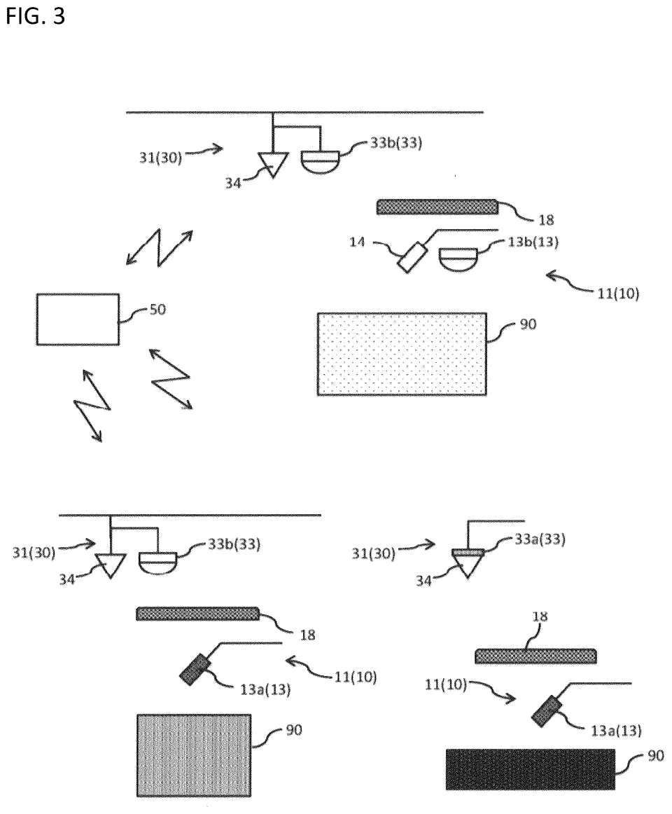

The first fire extinguishing part 10 may be a “fire erase” sold by NICHIBOU Co., Ltd. An activation time of the “fire erase” is, for example, about 30 seconds to 2 minutes. The first fire extinguishing part 10 may have a cylinder 16 filled with a fire extinguishing agent and a sensor tube 13a coupled to the cylinder 16. The sensor tube 13a is a member that functions as a first detection unit 13, and the sensor tube 13a may be melted by heat of a fire to inject a fire extinguishing agent from a first supply unit 14 or the melted portion of the sensor tube 13a. The first detection unit 13 may be a fire detector 13b (see the upper drawing of FIG. 3). In this case, in response to a command from a control unit 50 that has received a signal indicating that a fire has occurred from the fire detector 13b, a fire extinguishing agent is supplied from the first supply unit 14 of the first fire extinguishing part 10. In FIG. 1, the sensor tube 13a is disposed along a periphery of the protection target 90. The sensor tube 13a may be provided so as to also function as a first supply unit as described later (see a lower drawing of FIG. 3). The control unit 50 can communicate with the detection units 13, 23, and 33, the fire extinguishing parts 10, 20, and 30, and the like, and may start and/or stop the supply of the fire extinguishing agent and the supply of water from the fire extinguishing parts 10, 20, and 30 upon receiving a signal indicating that a fire has occurred from the detection units 13, 23, and 33 as in the fire detector 13b described above.

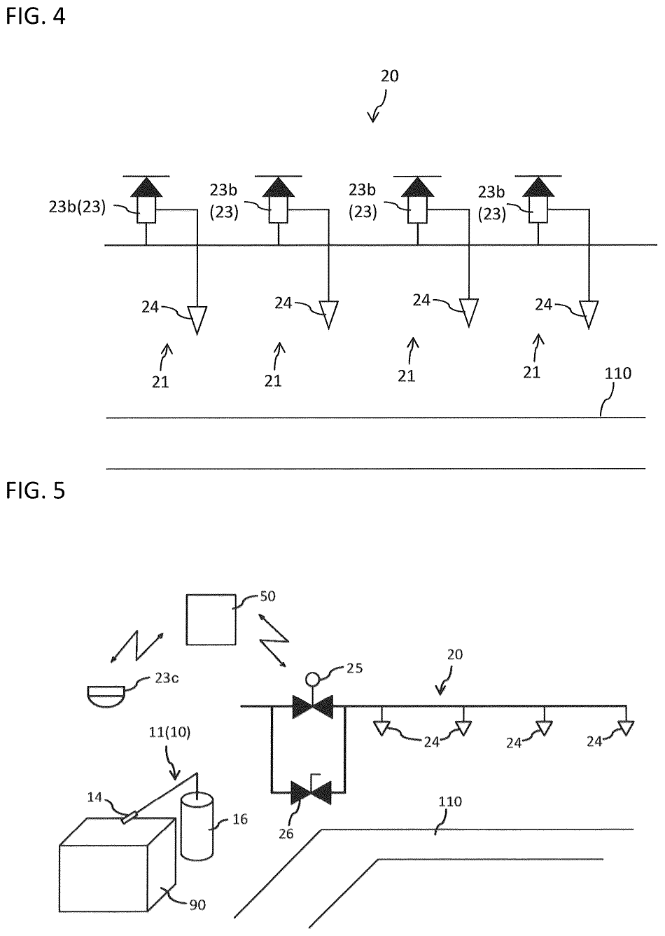

The second fire extinguishing part 20 may have a thermosensitive activation unit 23a as a second detection unit 23 activated by the heat of the fire, and the thermosensitive activation unit 23a may be decomposed and activated and start spraying (see FIG. 2). In a closed type sprinkler head, the thermosensitive activation unit 23a as the second detection unit 23 is integrated with a water spraying unit, and the thermosensitive activation unit 23a is decomposed by application of the heat, and as a result, spraying from the water spraying unit as a second supply unit 24 is performed (see FIG. 2). However, the present invention is not limited to such an aspect, and a thermosensitive open joint 23b may be used as the second detection unit 23, and an open type head may be used as the second supply unit 24 (see FIG. 4). In this case, the thermosensitive open joint 23b as the second detection unit 23 and the second supply unit 24 can be provided separately, and for example, the thermosensitive open joint 23b can be provided at a portion where the heat is likely to be accumulated or a portion along the evacuation route 110. In addition, when the thermosensitive open joint 23b is provided near the ceiling and the second supply unit 24 is provided at a portion where there is no spraying hazard, the second supply unit 24 can be provided at a portion where temperature reduction in the evacuation route 110 can be effectively realized. The second fire extinguishing part 20 may have a dedicated water source or a pump, or may supply water by being connected to water supply. Adopting the aspect of the water supply connection is advantageous in that it can be provided at low cost. The second fire extinguishing part 20 may be a sprinkler head, a mist supply unit, or the like, and these may use a fire extinguishing pump unit as a water source. In an area where a pressure of water supply is weak, a water amount and a pressure necessary for fire extinguishment can be secured by using the fire extinguishing pump unit as a water source. A second fire extinguishing unit 21 may be a sprinkler head. A water discharge amount of the sprinkler head may be 20 to 50 L/min at a water discharge pressure of 0.1 MPa. A third fire extinguishing part 30 described later may have the same configuration as the second fire extinguishing part 20.

The fire extinguishing agent supplied from the first fire extinguishing part 10 may include an inert new gas such as an inergen gas, a halocarbon new gas such as “Novec 1230 (FK-5-1-12)” sold by KOATSU CO., LTD., powders, or foam fire extinguishing chemicals (foam fire extinguishing agent). As shown in FIG. 3, the first fire extinguishing part 10 may have a plurality of first fire extinguishing units 11. Each of the first fire extinguishing units 11 may supply different types of fire extinguishing agents. However, the present invention is not limited to such an aspect, and each of the first fire extinguishing units 11 may supply the same type of fire extinguishing agent. There may be a plurality of protection targets 90, and at least one first fire extinguishing unit 11 may be provided corresponding to each of the protection targets 90.

The fire extinguishing agent may be Novec (registered trademark) or a PFAS-free foam fire extinguishing agent. Conventionally, Novec or the like is generally used in a closed space, but in the present embodiment, the method of use is different from the conventional method in that the Novec or the like is used in an open space. When the PFAS-free foam fire extinguishing agent is adopted, it is advantageous in that the influence on the human body and the environment can be further reduced. In a case of discharging the fire extinguishing agent with a gas, it is advantageous in that the gas reaches a narrow place even in devices or equipment having a complicated shape. When only the first fire extinguishing unit 11 corresponding to the protection target 90 activates, it is possible to prevent the fire extinguishing agent from being sprayed to a protection target 90 irrelevant to the occurrence of the fire. In a case of using the foam fire extinguishing agent, it is advantageous in terms of cost reduction. In addition, when a component having a small environmental load is used as the foam fire extinguishing agent, it is advantageous in that the treatment cost of the foam fire extinguishing agent can be reduced.

The protection target 90 may be, for example, a manufacturing device, a test device, equipment, a facility, a machine tool, or the like set in factories, laboratories, or the like. As an example, a device that supplies solder may be the protection target 90. By adopting such an aspect, it is possible to perform fire extinguishment for each of the protection targets 90 and to efficiently perform the fire extinguishing activity. The first fire extinguishing unit 11 provided in the protection target 90 may be provided toward a portion where fire extinguishment is considered to be necessary. For example, one of the first fire extinguishing units 11 may be provided toward a motor portion of the device, and another one of the first fire extinguishing units 11 may be provided toward a melting furnace. The first fire extinguishing unit 11 may be provided at a location separated by a short distance of 20 to 60 cm from the protection target 90.

As shown in FIG. 2, the second fire extinguishing part 20 may include a plurality of second fire extinguishing units 21 disposed along the evacuation route 110. When such an aspect is adopted, it is advantageous in that it is possible to spray water along the evacuation route 110 and it is possible to avoid a person from being damaged by a fire as much as possible. The sprinkler head may be provided on the ceiling, but the second supply unit 24 may be provided at a position below the ceiling along the evacuation route 110 (for example, in a range with a height from the ceiling of 100 to 200 cm) using the thermosensitive open joint 23b (see FIG. 4). By adopting such an aspect, it is possible to reliably spray water to the evacuation route 110, and it is possible to increase the possibility that an evacuation route for people can be secured. In the second fire extinguishing part 20, only the second fire extinguishing unit 21 around the fire may activate regardless of the activation status of the first fire extinguishing part 10. Alternatively, the second fire extinguishing part 20 may be activated by an activation signal of the first fire extinguishing part 10 and an activation signal of the fire detector 23c which is the second detection unit 23 provided near the ceiling of the activated first fire extinguishing part 10 (for example, a region located above the first fire extinguishing part 10 and within a circle within a radius of 5 m from the first fire extinguishing part 10 in plan view) (see FIG. 5). In this case, after the control unit 50 receives both the activation signal of the first fire extinguishing part 10 and the activation signal of the fire detector 23c, the control unit 50 sends a command to the second fire extinguishing part 20, and spraying of water from the second fire extinguishing part 20 is started. By adopting such an aspect, only the second fire extinguishing part 20 on the evacuation route corresponding to the protection target 90 in which the fire has occurred can be sprayed, and a worker around the fire can safely evacuate by relying on the evacuation route sprayed with water. At this time, the second fire extinguishing part 20 may be activated by an electric valve 25. In the present application, the “region located above the first fire extinguishing part 10 and within a circle within a radius of 5 m from the first fire extinguishing part 10 in plan view” described above is referred to as an “upper region of the first fire extinguishing part 10”.

A third fire extinguishing part 30 that sprays water may be provided for the protection target 90. The third fire extinguishing part 30 may spray water after starting supply of the fire extinguishing agent by the first fire extinguishing part 10. In a case where such an aspect is adopted, water is sprayed when the fire cannot be extinguished by the first fire extinguishing part 10. Some of the protection targets 90 such as devices are vulnerable to water, but by adopting this aspect, it is possible to prevent the protection targets 90 from being sprayed with water as much as possible. In a case of adopting an aspect in which a fire extinguishing agent is supplied from the cylinder 16 as the first fire extinguishing part 10, fire extinguishment cannot be performed when the fire extinguishing agent in the cylinder 16 disappears. Even in such an aspect, spreading of fire can be prevented by spraying water around the protection target 90 by the third fire extinguishing part 30, and a worker in the vicinity of the protection target 90 can also be protected from the fire. The third fire extinguishing part 30 may have a plurality of third fire extinguishing units 31. There may be a plurality of protection targets 90, and at least one third fire extinguishing unit 31 may be provided corresponding to each of the protection targets 90 (see FIG. 3). By adopting such an aspect, the fire extinguishing activity can be efficiently performed corresponding to each of the protection targets 90.

An activation temperature of the third fire extinguishing part 30 may be higher than an activation temperature of the first fire extinguishing part 10. By adopting such an aspect, when the first fire extinguishing part 10 is activated primarily to supply a fire extinguishing agent and the fire cannot be extinguished by the fire extinguishing agent, the third fire extinguishing part 30 is activated to spray water. As described above, some of protection targets 90 such as devices are vulnerable to water, but by adopting this aspect, it is possible to prevent the protection targets 90 from being sprayed with water as much as possible. Incidentally, the activation temperature of the first fire extinguishing part 10 is, for example, 90° C. to 95° C., and the activation temperature of the third fire extinguishing part 30 is, for example, 95° C. to 100° C. An activation temperature of the second fire extinguishing part 20 provided along the evacuation route 110 is, for example, 70° C. to 80° C. In this way, the activation temperature of the second fire extinguishing part 20 may be lower than the activation temperature of the first fire extinguishing part 10.

Conventionally, sprinklers and the like are provided on the entire floor. However, in the present embodiment, sprinklers and the like as the second fire extinguishing part 20 may not be provided on the entire floor, and fire extinguishment by only the first fire extinguishing part 10 or the first fire extinguishing part 10 and the third fire extinguishing part 30 may be performed on the protection target 90. However, the present invention is not limited to such an aspect, and although the sprinklers and the like are provided on the entire floor, the first fire extinguishing part 10 may be always provided for the protection target 90. Also in this case, when the first fire extinguishing part 10 activates first and the fire is not extinguished by the activation of the first fire extinguishing part 10, the second fire extinguishing part 20 may activate. It should be noted that factories and laboratories are not necessarily required to provide sprinklers as mandates.

In a case where the first fire extinguishing part 10, the second fire extinguishing part 20, and the third fire extinguishing part 30 are provided, the first fire extinguishing part 10 corresponding to the protection target 90 from which a fire has started may be first driven, the third fire extinguishing part 30 may be driven in a case where the fire extinguishment cannot be performed by the first fire extinguishing part 10, and the second fire extinguishing part 20 may be driven in a case where the fire extinguishment cannot be performed by the drive of the third fire extinguishing part 30. By adjusting the positions and activation temperatures of the detection units 13, 23, and 33, in a case where a fire has started from the protection target 90, the first fire extinguishing part 10, the third fire extinguishing part 30, and the second fire extinguishing part 20 may be driven in this order. Note that in a case where the fire does not start from the protection target 90 and the fire starts from the evacuation route 110, it is assumed that the second fire extinguishing part 20 activates first, and then the first fire extinguishing part 10 or the third fire extinguishing part 30 activates.

A distance from the protection target 90 to the first detection unit 13 for activating the first fire extinguishing part 10 may be shorter than a distance from the protection target 90 to the third detection unit 33 for activating the third fire extinguishing part 30. By adopting such an aspect, it is possible to more reliably drive first detection unit 13 faster than third detection unit 33. The third detection unit 33 may be the thermosensitive activation unit 33a or the fire detector 33b.

A shielding member 18 may be provided above the first detection unit 13 for activating the first fire extinguishing part 10 (see FIG. 3). By adopting such an aspect, the sensor tube 13a or the first supply unit 14 can be disposed between the shielding member 18 and the protection target 90. In the event of a fire, diffusion of heat is blocked by the shielding member 18, and the temperature between the shielding member 18 and the protection target 90 increases, which can promote melting of the sensor tube 13a. Furthermore, the fire extinguishing agent can be sprayed from the first supply unit 14 between the shielding member 18 and the protection target 90 to prevent the fire extinguishing agent from diffusing, thereby enhancing the fire extinguishing effect. On the other hand, in a case where the protection target 90 is a melting furnace, it is possible to prevent a solution scattered when a molten metal is taken out from the melting furnace from adhering to the sensor tube 13a or the first supply unit 14.

The second detection unit 23 for activating the second fire extinguishing part 20 may be provided apart from the third fire extinguishing part 30. The second fire extinguishing part 20 is provided along the evacuation route 110, whereas the third fire extinguishing part 30 is provided corresponding to the protection target 90. The third fire extinguishing part 30 sprays water around the protection target 90 to lower the temperature near the protection target 90 so that a worker can safely evacuate.

The second fire extinguishing part 20 may have, for example, a manual activation valve 26 and be manually activated. By adopting such an aspect, in addition to the aspect in which water is automatically supplied from the second fire extinguishing part 20, it is also possible for a person to manually supply water from the second fire extinguishing part 20. As a head as the second supply unit 24 of the second fire extinguishing part 20, a selective water spraying unit such as a drencher head may be used. When the drencher head is adopted, water can be sprayed in a vertically long shape such as a rectangular shape or an elliptical shape unlike the sprinkler that sprays water in a circular shape with respect to the floor, so that water can be effectively sprayed to the evacuation route 110.

When the first fire extinguishing part 10 is provided within a water spray range of the second fire extinguishing part 20, a water preventing member may be provided between the second fire extinguishing part 20 and the first fire extinguishing part 10. By providing such a water preventing member, it is possible to prevent the water supplied from the second fire extinguishing part 20 from reaching the first detection unit 13 and lowering the temperature of the first detection unit 13, and eventually, the first fire extinguishing part 10 from not activating properly. In addition, the above-described shielding member 18 may also function as the water preventing member.

The third fire extinguishing part 30 may also have, for example, a manual activation valve and be manually activated. As a head as the third supply unit 34 of the third fire extinguishing part 30, a selective water spraying unit such as a drencher head may be used. In addition, the third fire extinguishing part 30 may be a combination of a thermosensitive open joint and an open type head.

The above description of the embodiments and the disclosure of the figures are merely examples for describing the invention defined in the claims, and the invention defined in the claims is not limited by the above description of the embodiments and the disclosure of the figures. In addition, the description of the claims at the time of filing is only an example, and the description of the claims can be changed as appropriate based on the description of the description, figures, and the like.

### REFERENCE SIGNS LIST

10 First fire extinguishing part
11 First fire extinguishing unit
13 First detection unit
20 Second fire extinguishing part
21 Second fire extinguishing unit
23 Second detection unit
30 Third fire extinguishing part
33 Third detection unit
90 Protection target
110 Evacuation route

1. A fire extinguishing system comprising:
a first fire extinguishing part that supplies a fire extinguishing agent to a protection target; and
a second fire extinguishing part that sprays water to an evacuation route.

2. The fire extinguishing system according to claim 1,
wherein the fire extinguishing agent includes a gas, powders, or a foam fire extinguishing chemical.

3. The fire extinguishing system according to claim 1,
wherein the first fire extinguishing part has a plurality of first fire extinguishing units,
wherein there are a plurality of protection targets, and
wherein at least one first fire extinguishing unit is provided corresponding to each of the protection targets.

4. The fire extinguishing system according to claim 1,
wherein the second fire extinguishing part includes a plurality of second fire extinguishing units disposed along the evacuation route, and
wherein the fire extinguishing agent is not supplied to the evacuation route.

5. The fire extinguishing system according to claim 1 further comprising a third fire extinguishing part that sprays water to the protection target, and
wherein the third fire extinguishing part sprays water after starting supply of the fire extinguishing agent by the first fire extinguishing part.

6. The fire extinguishing system according to claim 5,
wherein an activation temperature of the third fire extinguishing part is higher than an activation temperature of the first fire extinguishing part.

7. The fire extinguishing system according to claim 5,
wherein a distance from the protection target to a first detection unit for activating the first fire extinguishing part is shorter than a distance from the protection target to a third detection unit for activating the third fire extinguishing part.

8. The fire extinguishing system according to claim 1,
wherein a shielding member is provided above a first detection unit for activating the first fire extinguishing part.

9. The fire extinguishing system according to claim 1,
wherein the second fire extinguishing part is manually activated.

10. The fire extinguishing system according to claim 1,
wherein the second fire extinguishing part is activated by an activation signal of the first fire extinguishing part and an activation signal of a second detection unit provided at an upper region of the first fire extinguishing part.

11. A fire extinguishing system comprising:
a first fire extinguishing part that supplies a fire extinguishing agent to a protection target; and
a second fire extinguishing part that sprays water to an evacuation route,
wherein an activation temperature of the second fire extinguishing part is lower than an activation temperature of the first fire extinguishing part.

12. A fire extinguishing system comprising:
a first fire extinguishing part that supplies a fire extinguishing agent to a protection target;
a second fire extinguishing part that sprays water to an evacuation route; and
a third fire extinguishing part that sprays water to the protection target,
wherein the third fire extinguishing part sprays water after starting supply of the fire extinguishing agent by the first fire extinguishing part, and
wherein the third fire extinguishing part is activated when the first fire extinguishing part cannot extinguish a fire.
